(19) United States
(12) Patent Application Publication
(10) Pub. No.: US 2010/0193262 A1
(43) Pub. Date: Aug. 5, 2010

(54) Light power-saving foldable electric wheelchair having a solar energy charging unit

(76) Inventor: Tianyun Zhao, Beijing (CN)

Correspondence Address: KILE GOEKJIAN REED & MCMANUS, 1200 NEW HAMPSHIRE AVE, NW, SUITE 570, WASHINGTON, DC, 20036, US

(21) Appl. No.: 12/667,686

(22) PCT Filed: Dec. 25, 2007
(86) PCT No.: PCT/CN07/71319

§ 371 Date: Jan. 4, 2010

(51) Int. Cl. B60K 16/00

(52) U.S. Cl. 180/2.2

(57) ABSTRACT

A light power-saving foldable electric wheelchair having a solar energy charging unit, A hand direction operation unit is fixed on a left elbow (10) to operate the concrete running direction of the electric wheelchair. The left and right rear wheels (3) are integrated with the motors (30) respectively, so as the two motors (30) can directly drive the two rear wheels (3). Two disc brakes (20) are installed on the left and right rear wheels (3), the two disc brakes (20) are connected to a brake handle (15) via the main steel wires (24), by means of the single hand pull brake handle (15), the left and right rear wheels (3) braked simultaneously. A solar energy battery plate (36) is installed at the upside of the wheelchair, the accumulator cell is supplied by the solar energy battery plate (36). And a cross foldable device (1.4˜1.48) is provided in the wheelchair frame (1).

### TECHNICAL FIELD

The present invention relates to the technical field of specific vehicles for senior folks and disabled persons, it is a kind of light power-saving foldable electric wheelchair having a solar energy charging unit.

### BACKGROUND OF THE INVENTION

Currently, the electric wheel chairs on the international market mainly come from oversea market, such as the United States, New Zealand, Taipei (the area reflects the miniature of international market), and etc. Some are assembled and imitated in Shanghai. They have the advantage of intellectual control rod. However, most of them are bulky, the weights of entire chairs are from 60 kg to 120 kg, and they are not foldable and have high power consumption. Besides, their running distance is too short. The main problem is that the design unilaterally pursues self-lock function to play a role at any moment. Consequently, a large amount of energy provides virtual power. The motor drives rear wheel indirectly by means of the self-locked worm-gearing system, and the intellectual control rod always monitors and controls the operation of vehicle. The two kinds of self-lock function make the electric wheel chair to be always under the status of ready for braking once it starts, so that it cannot realize to slip by power off. The high power consumption of worm-gearing and electric magnetic brake plus 20 kg to 30 kg of weight of lead-acid battery increases the weight and power consumption of the whole vehicle.

### SUMMARY OF THE INVENTION

The purpose of this invention is to overcome the shortcoming in the present electric wheel chair, it is a kind of light power-saving foldable electric wheelchair having a solar energy charging unit.

The electric wheel chair provides by this invention, comprising a frame of wheel chair and its vertical pipes, horizontal supporting pipes, main vertical pipes, under the frame there are rear wheels, a front direction wheel, a caster, between the vertical pipes and the main vertical pipes there are the left and right arm-rest pipes, the front ends of arm-rest pipes are bent as elbows, a hand control direction device is installed on the left elbow, a speed-adjust turning handle and a hand pull brake handle are installed on the right elbow, characterized in that:

Driving mode: a speed-adjusting turning handle is installed in the right elbow, under the left and right main vertical pipes, there are rear wheels and mounting vertical boards, the rear wheels with motors are installed on the vertical board by screws and nuts, two motors are DC and brushless motors with stepless adjustable speed, low rotation speed, and high torque, the housings of the motors are integrated with the steel wheel plates, so as the two motors can directly drive the two rear wheels;

Braking mode: two disc brakes are installed on the left and right rear wheels, the disc brake includes a disc brake sheet, a brake clamp and a brake rod, the disc brake sheet is installed by the side of the motor by means of tightly screwing the female screw of the disc brake sheet in the male screw on the end-cover of the motor, the brake clamp and the brake rod are fixed on the vertical board via the connecting plate with screws; a hand pull brake handle is installed on the right elbow; the two disc brakes are connected to the brake handle through a delta-shaped conversion plate via a braking steel wire, the upper end of the delta-shaped conversion plate is connected to the brake handle via the main steel wire, the left and right lower ends of the delta-shaped conversion plate are connected to the left and right brake rods via the left and right branch steel wires respectively, by means of a single hand to pull brake handle or by means of a small electric device to pull the main steel wire, the brake rods are tightly pulled so that the two brake clamps tightly clip the two brake sheets, and the two rear wheels are braked simultaneously;

Charging mode: upside the wheel chair there is a solar energy battery plate, a wire connecting case of the solar energy battery plate is connected to a charging controller of the solar energy battery plate, a charging plug of the charging controller is inserted into the charging socket of the battery box.

The present light power-saving foldable electric wheel chair is light (the total weight including lithium ion batteries is only 29 Kg), foldable with batteries, convenient to go upstairs and enter rooms or to be put into the baggage cabinets of cars, of very power-saving, able to run a long distance, good at climbing slopes, its speed is selectable from 7 km/h to 12 km/h, and it is convenient for disabled persons and senior folks to use.

### DESCRIPTION OF THE FIGURES

FIG. 1 shows the first schematic drawing of the configuration of the light power-saving foldable electric wheel chair having a solar energy charging unit.

FIG. 2 shows the schematic drawing of the composition of hand control direction device.

FIG. 3 shows the schematic drawing of the installation positions of the rear wheel directly driving motors and the two disc brakes how to braking simultaneously.

FIG. 4 shows the schematic drawing of the cross foldable device of the light power-saving foldable electric wheel chair.

FIG. 5 shows, in the view from back, the cross foldable device of the light power-saving foldable electric wheel chair.

FIG. 6 shows the second schematic drawing of the configuration of the light power-saving foldable electric wheel chair having a solar energy charging unit (the intellectual control rod 40, instead of two switches 18 for positive or inversion running of the left and right motors, is installed on the right elbow 12, the rests of the configuration remain the same).

### DESCRIPTION OF EMBODIMENTS

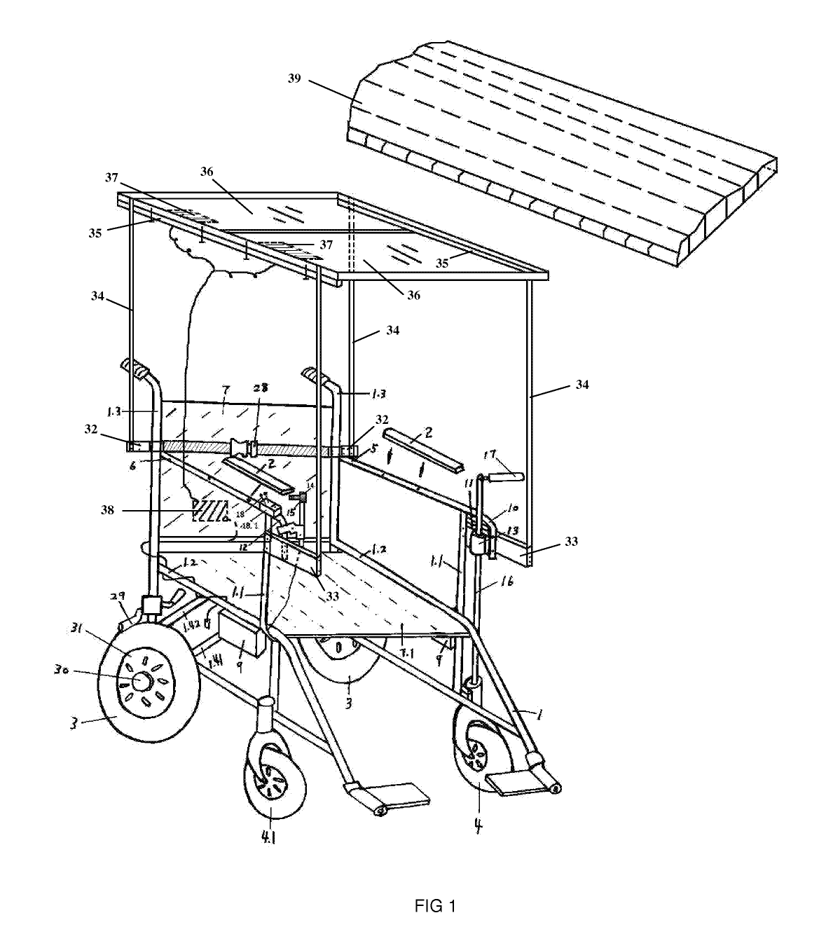

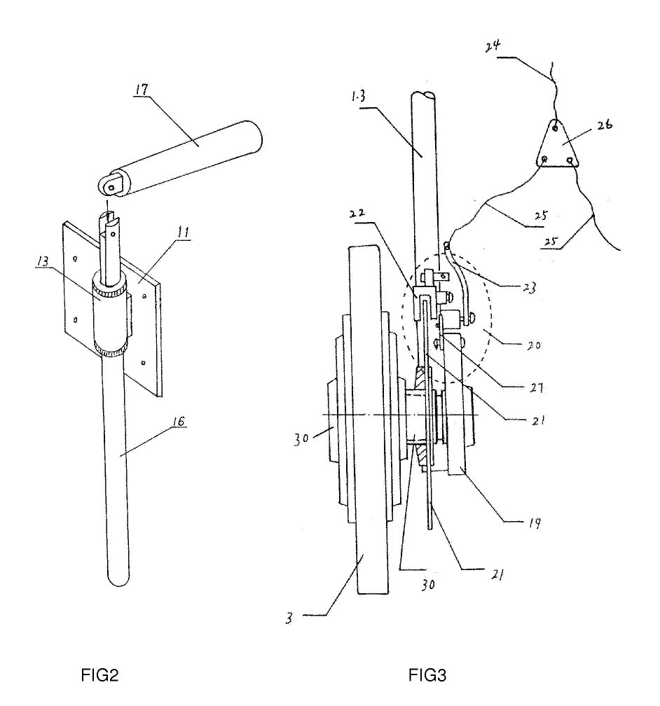

The present invention provides a kind of light power-saving foldable electric wheel chair having a solar energy charging unit comprising a frame of wheel chair 1 (see FIG. 1), two vertical pipes 1.1, two horizontally supporting pipes 1.2, two main vertical pipes 1.3, two rear wheels 3, a front direction wheel 4, a front caster 4.1, a left arm-rest pipe 5, a right arm-rest pipe 6 and two arm-rests 2, wherein the front ends of the left and right arm-rest pipes 5 and 6 are bent as elbows, a speed-adjust turning handle 14 and a hand pull brake handle 15 are installed on the right elbow 12, there is a fixing plate 11 between the left elbow 10 and the vertical pipe 1.1, a hollow bearing 13 is welded on the fixing plate 11, in addition, there is a vertical hand control rod 16 inserting through the hollow bearing 13, the upper end of the vertical hand control rod is connected to the hand control direction handle 17, the lower end of the rod is connected to the front direction wheel 4, in order to control the specific running direction of the electric wheel chair; (see FIGS. 2 & 1)

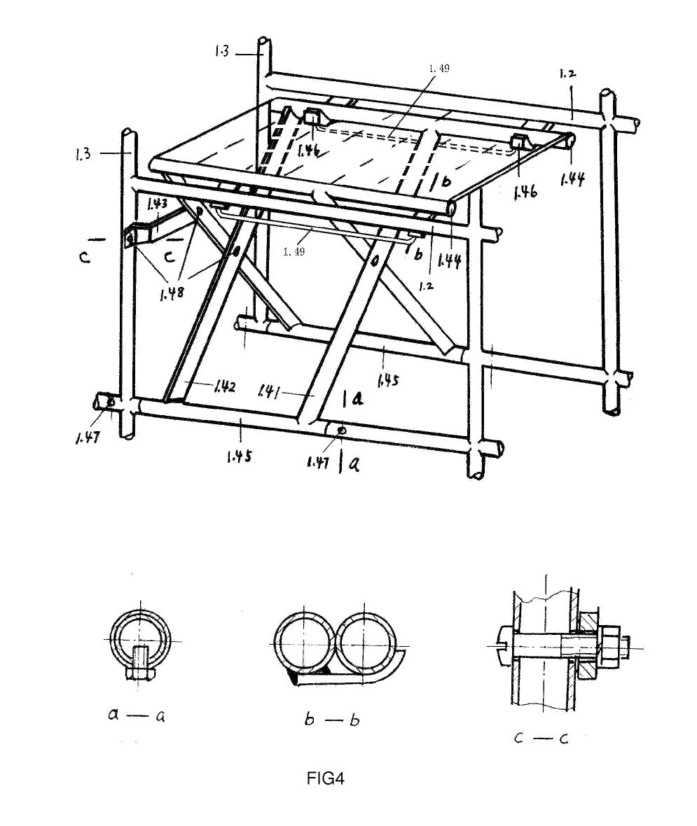

There are two mounting vertical boards 19 (see FIGS. 3 & 1) for the rear wheels at the lower end of the left and right main vertical pipes 1.3 respectively, the rear wheels 3 with direct driving motors 30 are secured on the vertical boards 19 by bolts and nuts, the said motors 30 are DC and brushless motors with stepless adjustable speed, low rotation speed, and high torque, the housings of the motors 30 are integrated with the steel wheel plates 31, so as the two motors 30 can directly drive the two rear wheels 3 to go forward and backward or to turn left and right in situ by means of switching two switches 18 and turning the speed-adjust turning handle 14 (or by means of only switching the intellectual control rod 32);

There are two nickel-hydrogen battery boxes 9 for the two motors 30, the two boxes are hung up from the left and right long flat vertical plates 1.49, to simplify the frame structure and to be convenient for hanging and unhanging batteries (with small capacity of lead-acid batteries to replace the nickel-hydrogen batteries, the battery boxes are hung up from the long flat vertical plates 1.49 in the same way);

In addition, a disc brake device is established (see FIGS. 3 & 1), the disc brake device is composed of two disc brakes 20, a hand pull brake handle 15, a main steel wire 24, two branch wires 25, a delta-shaped conversion plate 26, and a connecting plate 27, the disc brake includes a disc brake sheet 21, a brake clamps 22 and a brake rod 23, the disc brake 20 is installed by the side of the motor 30 by means of tightly screwing the female screw of the disc brake sheet 21 in the male screw on the end-cover of the motor 30, the brake clamps 22 and the brake rods 23 are fixed on the vertical boards 19 via the connecting plates 27, the hand pull brake handle 15 is installed on the right elbow 12, one end of the main steel wire 24 is connected to the brake handle 15, another end is connected to the upper end of the delta-shaped conversion plate 26, one end of each of the left and right branch steel wires 25 is connected to the left and right lower ends of the delta-shaped conversion plate 26 respectively, another end is connected to the brake rods 23 of disc brakes 20 of the left and right rear wheels respectively, in this way the two rear wheels braked simultaneously by means of a single hand to pull brake handle (or by means of a small electric device to draw the main steel wire 24).

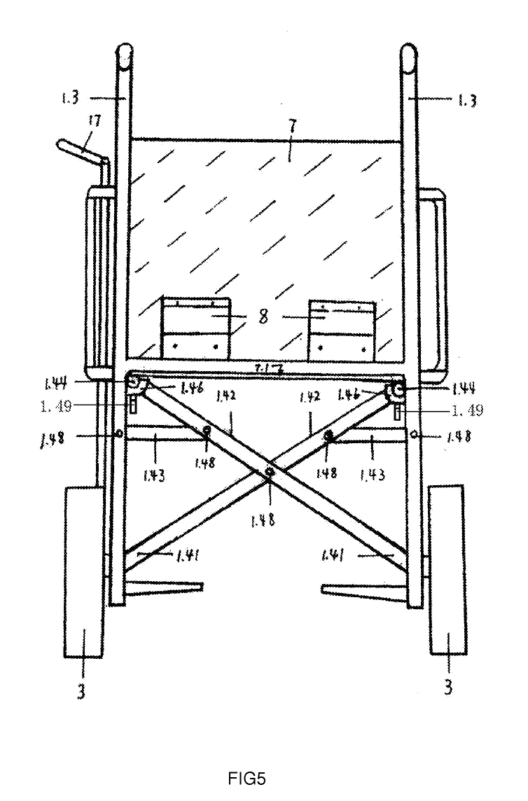

There is the cross foldable device (1.41-1.48) in the wheel chair frame 1 (see FIGS. 4 & 5), its base is the two front cross pipes 1.41 and two rear cross boards 1.42, the upper ends of the two front cross pipes 1.41 and two rear cross boards 1.42 are connected by welding to the left and right horizontally supporting pipes 1.44 of the cushion 7.1, the lower ends of the two front cross pipes 1.41 and two rear cross boards 1.42 are connected by welding to two short pipes 1.45, which may rotate around its inner pipe, in addition, there are two cross fold positioning boards 1.43, which make the fold and interaction between the two rear cross boards 1.42 and the left and right main vertical pipes 1.3 keep stable by means of four slip-connecting screws 1.48, there are four inner pipe fixing screws 1.47 out of the two ends of the left and right short pipes 1.45 respectively, the screws tightly fix the inner pipes and non-turning outer pipes, there are totally four hook-shaped supporters 1.46, which are welded at the front and rear of the left and right horizontally supporting pipes 1.2 and at the bottom planes tightly close to the supporting pipes 1.2, and used to support the left and right horizontally supporting pipes 1.44 of the cushion 7.1; all of the parts mentioned above constitute the cross foldable device of the light power-saving foldable electric wheel chair.

A switching case 18.1 is installed on the right arm-rest pipe 6, two switches 18 for positive or inversion running of the motors are installed on the switching case 18.1, those switches 18 coordinate with speed-adjusting turning handle 14 together to control the main running direction of the light power-saving foldable electric wheel chair, namely to go forward and backward or to turn left and right in situ.

A safe belt 28 is equipped on the cushion 7 of the chair. Two handbrakes 29 are installed at the left and right lower parts of the main vertical pipe 1.3 of the chair. Two or one control box 8 (to be connected from two to one to install the intellectual control rod 40), which is installed on the back of the cushion 7 of the chair, fixed by nuts.

Two double vertical boards 32 are secured on two main vertical pipes 1.3 respectively, another two double vertical boards 33 are secured on the left and right elbow of the arm-rest pipes 5, 6 and the vertical pipes 1.1, four square vertical pipes 34 are secured on both double vertical pipes 32, 33 respectively, between the top of the two left vertical square pipes and between the top of the two right vertical square pipes are secured two horizontal square pipes 35 respectively, both of the two horizontal square pipes 35 have the same installing holes to connect the solar energy battery plate 36 by corresponding holes and nuts, the solar energy battery plate 36 is installed on the horizontal square pipes 35 by nuts, the wire connecting case 37 of the solar energy battery plate 36 is connected to a charging controller 38 of the solar energy battery plate through conducting wires, a charging plug of the charging controller 38 is inserted into the charging socket of the battery box 9, there is a rain-proof and dust-proof cover 39 upon the solar energy battery plate 36, it can protect the driver and the solar energy battery plate in the rain season.

The solar energy charging mode can't replace all of the traditional electric charging mode, if it is in rainy season, the solar energy charging mode must be replaced by the traditional charging mode at this time, the solar energy battery could be transferred to a sunning flat roof to wait for sunshine, and the rain-proof and dust-proof cover 39 could be put on the wheel chair, then the light power-saving foldable electric wheel chair will be a rain-proof and dust-proof running shed.

Band brakes may be installed on the left and right rear wheels to replace the disc brakes when it is practically implemented. One end of the band brake is tightly secured with its own female screw screwing in the male screw on the end-cover of the rear wheel motor 30, another end of the band brake is connected to hand pull brake handle 15 via the main steel wire 24; the main steel wire 24 is connected to the left and right branch steel wires 25 via the delta-shaped conversion plate 26, and draws the two branch steel wires 25 to control the braking rod of the left and right band brakes respectively, to attain the safe effect of two band brakes braking simultaneously by means of a single hand to pull the brake handle 15, or by means of a small electric device to draw the main steel wire 24.

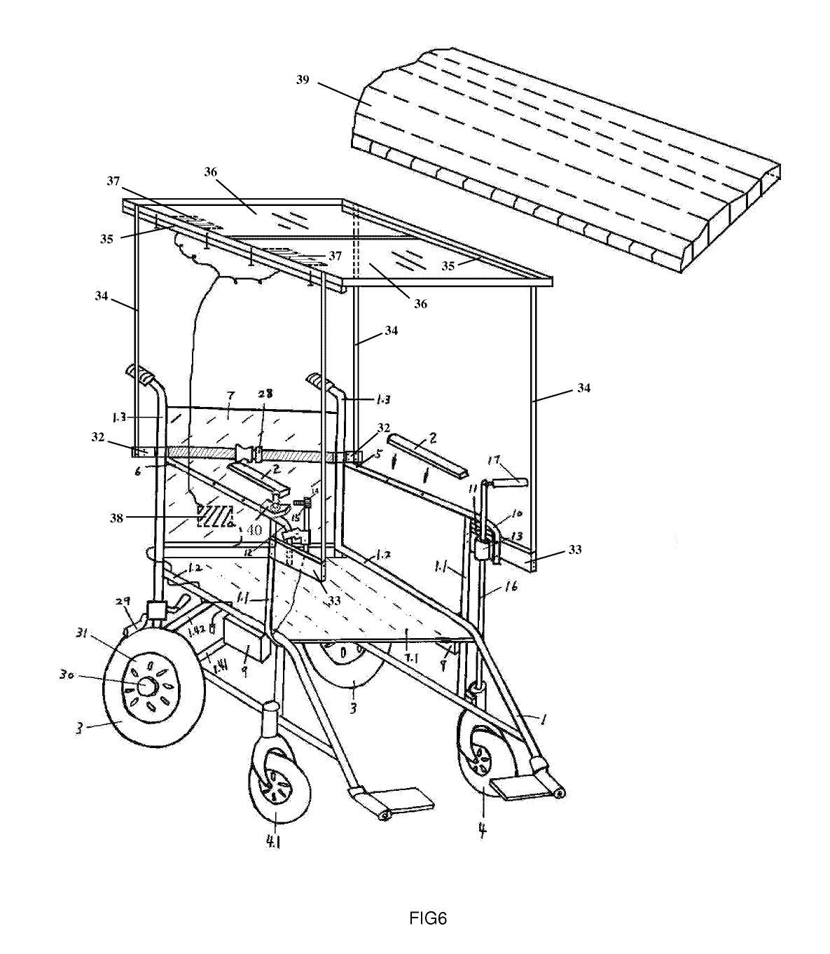

The intellectual control rod 40 (see FIG. 6) could be installed on the right elbow 12 to replace the speed-adjusting turning handle 14 and the switches 18 for positive or inversion running when it is practically implemented, the rod 40 will interact with the hand control direction handle 17: The intellectual control rod lays stress on gross adjustment, namely to control the current and the main running direction of electric wheel chair, which goes forward and backward or turns left and right in situ; On the other hand, the hand control direction handle 17 lays stress on fine adjustment, and it accurately controls and adjusts the specific running direction of electric wheel chair. The advantage of installing the intellectual control rod is easy to operate without repeatedly switching two switches 18 for positive or inversion running of the motors, and its shortcoming is to raise the cost and price. While you install the intellectual control rod, you must maintain the hand pull brake handle 15, and maintain the speed-adjusting turning handle 14, you must keep these control mode exist at the same time to avoid accident or getting tired by single control mode.

What is claimed is:

1. A kind of A light power-saving foldable electric wheelchair having a solar energy charging unit, comprising a frame of wheel chair (1), two vertical pipes (1.1), two horizontally supporting pipes (1.2), two main vertical pipes (1.3), a cross foldable device (1.41) (1.42) is provided in the wheelchair frame (1), two rear wheels (3), a front direction wheel (4), a front caster (4.1), a left arm-rest pipes (5) a right arm-rest pipe (6), and two arm-rests (2), the front ends of the left and right arm-rest pipes (5) and (6) are bent as elbows (10, 12), a hand control direction device is installed on the left elbow (10), a speed-adjusting turning handle (14) and a hand pull brake handle (15) are installed on the right elbow (12), characterized mainly in that:
Driving mode: a speed adjusting turning handle (14) is installed on the right elbow (12), there are two mounting vertical boards (19) of the rear wheels at the lower end of the left and right main vertical pipes (1.3) respectively, the rear wheels (3) with motors (30) are secured on the vertical boards (19) by bolts and nuts, the said motors (30) are DC and brushless motors with stepless adjustable speed, low rotation speed, and high torque, the housing of the motors (30) are integrated with the steel wheel plates (31), so as the two motors (30) can directly drive the two real wheels (3);
Braking mode: two disc brakes (20)are installed on the left and right rear wheels, the disc brake includes a disc brake sheet (21), a brake clamp (22) and a brake rod (23), the disc brake sheet (21) is installed by the side of the motor (30) by means of tightly screwing the female screw of the disc brake sheet (21) in the male screw on the end-cover of the motor (30), the brake clamp (22) and the brake rod (23) are fixed on the vertical board (19) via the connecting plate (27) with screws; a hand pull brake handle (15) is installed on the right elbow (12); the two disc brakes (20) are connected to the brake handle (15) through a delta-shaped conversion plate (26) via a braking steel wire, the upper end of the delta-shaped conversion plate (26) is connected to the brake handle (15) via the main steel wire (24), the left and right lower ends of the delta-shaped conversion plate (26) are connected to the left and right brake rods (23) via the left and right branch steel wires (25) respectively, by means of a single hand to pull brake handle (15) or by means of a small electric device to pull the main steel wire (24), the brake rods (23) are tightly pulled so that the two brake clamps (22) tightly clip the two brake sheets (21), and the two rear wheels (3) are braked simultaneously;
Charging mode: there is a new type of solar energy battery plate (36) installed on the upside of the electric wheel chair, a wire connecting case (37) of the solar energy battery plate (36) is installed through conducting wire to a solar energy battery controller (38) which is a new type of fast-charging and fast-discharging, put the plug of the battery controller (38) into the socket of the left or right accumulator cells box (9), so as the electric wheel chair could be charging while running charging by left battery box and discharging by right battery box, or exchange the charging or discharging each other.

2. The light power-saving foldable electric wheelchair having a solar energy charging unit of claim 1, characterized in that: two double vertical boards (32) are secured on two main vertical pipes (1.3) respectively, another two double vertical boards (33) are secured on the left and right elbow of the arm-rest pipes (5, 6) and the vertical pipes (1.1), four square vertical pipes (34) are secured on both double vertical pipes (32, 33) respectively, between the top of the two left vertical square pipes and between the top of the two right vertical square pipes are secured two horizontal square pipes (35) respectively, both of the two horizontal square pipes (35) have the same installing holes to connect the solar energy battery plate (36) by corresponding holes and nuts.

3. The light power-saving foldable electric wheelchair having a solar energy charging unit of claim 2, characterized in that: there is a rain-proof and dust-proof cover (39) upon the solar energy battery plate (36).

4. The light power-saving foldable electric wheelchair having a solar energy charging unit of claim 1, characterized in that: there is a cross foldable device in the wheel chair frame (1), its base is two front cross pipes (1.41) and two rear cross boards (1.42), the upper end of the two front cross pipes (1.41) and two rear cross boards (1.42) are connected by welding to the left and right horizontally supporting pipes (1.44) of the cushion (7.1), the lower ends of the two front cross pipes (1.41) and two rear cross boards (1.42) are connected by welding to the left and right short pipes (1.45), which may rotate around its inner pipe at a small angle; two cross fold positioning boards (1.43) make the fold and interaction between the two rear cross boards (1.42) and the left and right main vertical pipes (1.3) keep stable by means of four slip-connecting screws (1.48), the cross points of the two front cross pipes (1.41) and the two rear cross boards (1.42) are also connected to each other via the slip-connecting screws (1.48), there is an inner pipe fixing screw (1.47) out of the two ends of the left and right short pipes (1.45) respectively, the screws tightly fix the inner pipes and non-turning outer pipes, there are totally four hook-shaped supporters (1.46) which are welded at the front and rear of the left and right horizontally supporting pipes (1.2) and at the bottom planes tightly close to the supporting pipes (1.2), and used to support the left and right horizontally supporting pipes (1.44) of the cushion (7.1), two long flat vertical plates (1.49) are welded beneath each of the two left hook-shaped supporters and the two right hook-shaped supporters (1.46) respectively for hanging and unhanging the left and right battery boxes (9) conveniently, therefore the electric wheel chair is foldable even with batteries.

5. The light power-saving foldable electric wheelchair having a solar energy charging unit of claim 4, characterized in that: a switching case (18.1) is installed on the right arm-rest pipe (6), two switches (18) for positive or inversion running of the motors and the power display are installed on the switching case (18.1).

6. The light power-saving foldable electric wheelchair having a solar energy charging unit of claim 1, characterized in that: there is a hand control direction device on the left elbow (10), and the hand control direction device includes a fixing plate (11), a hollow bearing (13), a vertical hand control rod (16), a hand control direction handle (17), the vertical hand control rod (16) inserting through the hollow bearing (13), its upper end is connected to the hand control direction handle (17), its lower end is connected to the front direction wheel (4).

7. The light power-saving foldable electric wheelchair having a solar energy charging unit of claim 1, characterized in that: there are nickel-hydrogen accumulator cells within two battery boxes (9), two nickel-hydrogen battery boxes are hung on two left and right long flat vertical plates (1.49) respectively.

8. The light power-saving foldable electric wheelchair having a solar energy charging unit of claim 7, characterized in that: the said nickel-hydrogen battery may be replaced by small capacity lead-acid batteries, which are also hung up from the said long flat vertical plates (1.49) respectively.

9. The light power-saving foldable electric wheelchair having a solar energy charging unit of claim 1, characterized in that: band brakes may be installed on the left and right rear wheels (3) to replace the disc brakes, one end of the band brake is tightly secured with its own female screw screwing in the male screw on the end-cover of the rear wheel motor (30), another end of the band brake is connected to hand pull brake handle (15) via the main steel wire (24), the main steel wire (24) is connected to the left and right branch steel wires (25) via the delta-shaped conversion plate (26), and draws the two branch steel wires (25) to control the braking rods (23) of the left and right band brakes respectively.

10. The light power-saving foldable electric wheelchair having a solar energy charging unit of claim 5, characterized in that: an intellectual control rod (40) is installed on the right elbow (12) to replace the speed-adjusting turning handle (14) and switches (18) for positive or inversion running, the intellectual control rod (40) will interact with the hand control direction handle (17).

11. The light power-saving foldable electric wheelchair having a solar energy charging unit of claim 2, characterized in that: there is a cross foldable device in the wheel chair frame (1), its base is two front cross pipes (1.41) and two rear cross boards (1.42), the upper end of the two front cross pipes (1.41) and two rear cross boards (1.42) are connected by welding to the left and right horizontally supporting pipes (1.44) of the cushion (7.1), the lower ends of the two front cross pipes (1.41) and two rear cross boards (1.42) are connected by welding to the left and right short pipes (1.45), which may rotate around its inner pipe at a small angle; two cross fold positioning boards (1.43) make the fold and interaction between the two rear cross boards (1.42) and the left and right main vertical pipes (1.3) keep stable by means of four slip-connecting screws (1.48), the cross points of the two front cross pipes (1.41) and the two rear cross boards (1.42) are also connected to each other via the slip-connecting screws (1.48), there is an inner pipe fixing screw (1.47) out of the two ends of the left and right short pipes (1.45) respectively, the screws tightly fix the inner pipes and non-turning outer pipes, there are totally four hook-shaped supporters (1.46) which are welded at the front and rear of the left and right horizontally supporting pipes (1.2) and at the bottom planes tightly close to the supporting pipes (1.2), and used to support the left and right horizontally supporting pipes (1.44) of the cushion (7.1), two long flat vertical plates (1.49) are welded beneath each of the two left hook-shaped supporters and the two right hook-shaped supporters (1.46) respectively for hanging and unhanging the left and right battery boxes (9) conveniently, therefore the electric wheel chair is foldable even with batteries.

12. The light power-saving foldable electric wheelchair having a solar energy charging unit of claim 3, characterized in that: there is a cross foldable device in the wheel chair frame (1), its base is two front cross pipes (1.41) and two rear cross boards (1.42), the upper end of the two front cross pipes (1.41) and two rear cross boards (1.42) are connected by welding to the left and right horizontally supporting pipes (1.44) of the cushion (7.1), the lower ends of the two front cross pipes (1.41) and two rear cross boards (1.42) are connected by welding to the left and right short pipes (1.45), which may rotate around its inner pipe at a small angle; two cross fold positioning boards (1.43) make the fold and interaction between the two rear cross boards (1.42) and the left and right main vertical pipes (1.3) keep stable by means of four slip-connecting screws (1.48), the cross points of the two front cross pipes (1.41) and the two rear cross boards (1.42) are also connected to each other via the slip-connecting screws (1.48), there is an inner pipe fixing screw (1.47) out of the two ends of the left and right short pipes (1.45) respectively, the screws tightly fix the inner pipes and non-turning outer pipes, there are totally four hook-shaped supporters (1.46) which are welded at the front and rear of the left and right horizontally supporting pipes (1.2) and at the bottom planes tightly close to the supporting pipes (1.2), and used to support the left and right horizontally supporting pipes (1.44) of the cushion (7.1), two long flat vertical plates (1.49) are welded beneath each of the two left hook-shaped supporters and the two right hook-shaped supporters (1.46) respectively for hanging and unhanging the left and right battery boxes (9) conveniently, therefore the electric wheel chair is foldable even with batteries.

13. The light power-saving foldable electric wheelchair having a solar energy charging unit of claim 2, characterized in that: there is a hand control direction device on the left elbow (10), and the hand control direction device includes a fixing plate (11), a hollow bearing (13), a vertical hand control rod (16), a hand control direction handle (17), the vertical hand control rod (16) inserting through the hollow bearing (13), its upper end is connected to the hand control direction handle (17), its lower end is connected to the front direction wheel (4).

14. The light power-saving foldable electric wheelchair having a solar energy charging unit of claim 3, characterized in that: there is a hand control direction device on the left elbow (10), and the hand control direction device includes a fixing plate (11), a hollow bearing (13), a vertical hand control rod (16), a hand control direction handle (17), the vertical hand control rod (16) inserting through the hollow bearing (13), its upper end is connected to the hand control direction handle (17), its lower end is connected to the front direction wheel (4).

15. The light power-saving foldable electric wheelchair having a solar energy charging unit of claim 2, characterized in that: there are nickel-hydrogen accumulator cells within two battery boxes (9), two nickel-hydrogen battery boxes are hung on two left and right long flat vertical plates (1.49) respectively.

16. The light power-saving foldable electric wheelchair having a solar energy charging unit of claim 3, characterized in that: there are nickel-hydrogen accumulator cells within two battery boxes (9), two nickel-hydrogen battery boxes are hung on two left and right long flat vertical plates (1.49) respectively.

17. The light power-saving foldable electric wheelchair having a solar energy charging unit of claim 2, characterized in that: band brakes may be installed on the left and right rear wheels (3) to replace the disc brakes, one end of the band brake is tightly secured with its own female screw screwing in the male screw on the end-cover of the rear wheel motor (30), another end of the band brake is connected to hand pull brake handle (15) via the main steel wire (24), the main steel wire (24) is connected to the left and right branch steel wires (25) via the delta-shaped conversion plate (26), and draws the two branch steel wires (25) to control the braking rods (23) of the left and right band brakes respectively.

18. The light power-saving foldable electric wheelchair having a solar energy charging unit of claim 3, characterized in that: band brakes may be installed on the left and right rear wheels (3) to replace the disc brakes, one end of the band brake is tightly secured with its own female screw screwing in the male screw on the end-cover of the rear wheel motor (30), another end of the band brake is connected to hand pull brake handle (15) via the main steel wire (24), the main steel wire (24) is connected to the left and right branch steel wires (25) via the delta-shaped conversion plate (26), and draws the two branch steel wires (25) to control the braking rods (23) of the left and right band brakes respectively.
